(19) United States
(12) Patent Application Publication
(10) Pub. No.: US 2009/0307099 A1
(43) Pub. Date: Dec. 10, 2009

(54) Drag-and-Drop Communication of Data Via a Computer Network

(76) Inventors: Murat M. Tanik, Birmingham, AL (US); Leon Jololian, Summit, NJ (US); Rajani Shankar Sadasivam, Birmingham, AL (US)

Correspondence Address: Ballard Spahr LLP, SUITE 1000, 999 PEACHTREE STREET, ATLANTA, GA, 30309-3915, US

(21) Appl. No.: 11/988,511

(22) PCT Filed: Jul. 10, 2006
(86) PCT No.: PCT/US2006/026563

§ 371 Date: Mar. 31, 2009

Related U.S. Application Data
(60) Provisional application No. 60/697,486, filed on Jul. 8, 2005.

(51) Int. Cl. G06Q 30/00; G06Q 50/00; G06F 3/048; G06F 15/16; G06N 5/02

(52) U.S. Cl. 705/26; 705/34; 715/769; 709/202; 706/47

(57) ABSTRACT

The present invention provides a system, method, and computer program product for consuming Web Services, and is composed of two parts. The first component of the present invention is a Web Services agent known as HERMES (Heterogeneous Resources Management Enterprise System), which provides a uniform application interface for accessing a plurality of heterogeneous Web Services. The second component of the present invention, known as the 1-Drag Icon or system, provides a uniform user interface for accessing Web Services, and in one embodiment provides a uniform graphical user interface (GUI) component for the consumption of Web Services. HERMES and the 1-Drag Icon may be used separately or combined to provide a complete system for the consumption of Web Services.

### CROSS-REFERENCE TO RELATED APPLICATIONS

This application claims priority under 35 U.S.C. §119 to U.S. Provisional Patent Application Ser. No. 60/697,486, entitled “Drag-and-Drop Communication of Data Via a Computer Network,” filed on Jul. 8, 2005, which is herein incorporated by reference in its entirety.

### BACKGROUND OF THE INVENTION

Improvements in internet technology have increased the types and number of e-commerce web sites, applications, and interfaces. In the past, companies offered their products and services online by creating web sites on the internet. Under this traditional e-commerce model, a customer uses a web browser, navigates to the web site of the company using a Uniform Resource Locator (URL), registers his or her user and financial information, selects one or more offered products, and purchases the selected products. As the number of e-commerce web sites has grown, an increasing burden is placed on the customer to remember URLs and other necessary details such as login and password in order to purchase products and services online. In addition to having to recall and associate information for each particular e-commerce web site, the customer has the additional burden of understanding and using the different user interfaces that e-commerce companies provide.

The introduction of the Web Services model has further increased the burdens on the online consumer. The Web Services model is based on the Service model of loosely coupled network components in which processes can be dynamically constructed at run time. The Web Services model facilitates creating open distributed systems, which allows companies to make their services available worldwide through Web Services Description Language (WSDL) interfaces. Furthermore, the Web Services model allows creating new Services by composing existing Services together. Many companies such as amazon.com and google.com are now offering their products and services as WSDL or other service interfaces.

Currently, there are two ways that end users or consumers such as companies or individuals can use the Web Service products and services offered on the Internet in the form of WSDL interfaces. First, consumers can rely on third party companies to provide customized interfaces for consuming the services. However, there are inherent disadvantages to this approach. For example, the customer has to remember the URLs and other information necessary to access the services. They also have to understand and use different user interfaces for different services. By relying on third party companies to provide composed services, the effectiveness and flexibility of the Web Services model is greatly reduced.

The second way in which consumers can access a Web Service is to build a custom application using the WSDL or other service interfaces provided by the Web Service provider. A custom application combines an agent for interacting with the Web Service, as well as a user interface for the end user of the application. Such a custom application requires the user to enter consumer specific information in order to use the custom application. An important consideration is that as the number of Web Services grows, consumers will desire to switch between the products and services that are offered by different Web Service providers. Therefore, a consumer with a custom Web Service application has no ready means of accessing other Web Services. Further, the consumer will incur additional costs for each custom application as well as encounter different user interfaces. Thus, many of the same obstacles presented by traditional online e-commerce web sites are also present in the Web Services arena.

To overcome these deficiencies present in prior art e-commerce systems, and particularly Web Service e-commerce systems, several systems and methods are needed. First, what is needed is a system and method for consuming Web Services which provides the ease and familiarity of the graphical desktop environment which is familiar to most users. As in known in the art, when a user logs into her computer, she logs into a graphical desktop environment. The user can then perform a variety of tasks such as sending emails, or word processing by connecting to or executing applications using desktop icons. That is, the user has the ability to consume locally deployed services using graphical icons. Therefore, what is needed is system and method for consuming Web Services or local services which provides the ease and uniformity of a graphical desktop environment.

Second, what is needed is a Web Services agent that provides for easily managing and installing Web Services. What is also needed from the system is to provide a uniform and transparent communication interface to access heterogeneous Web Services provided by a plurality of Web Service vendors.

Finally, what is also needed is the combination of a Web Services agent and a uniform graphical desktop environment so that end users can manage, install, transparently use, and efficiently consume Web Services or other resources from a plurality of providers.

### SUMMARY OF THE INVENTION

The system, method, and computer program product of the present invention overcomes the deficiencies in the prior art by providing a Services agent as well as a Services user interface. The term Services in the various embodiments of present application refers to Web Services, web pages, the transfer protocols such as FTP, network or local applications or services such as email programs, word processing programs, image manipulation programs, database access programs, computer games, or any local or remote binary file, text file, media, source of information, product, service, or information in any form. A Services provider is any provider of a Service, whether local or remote. A task as used in the present application refers to a Service or group of Services.

The Services agent of the present application, HERMES, interacts with one or more Service providers and presents a uniform Services communication interface for a consumer or an application. HERMES in one embodiment provides a plug-in mechanism to easily manage and install multiple Services. The system and method of the present application also provides a graphical user interface, known as the 1-Drag Icon or system, which provides a uniform and familiar means for an end user to define, use, and consume Services. In one embodiment of the present application, the 1-Drag system facilitates consumption of Services through a mode of operation similar to that of using graphical icons in a Graphical User Interface (GUI).

Embodiments of the present application also combine HERMES and the 1-Drag Icon to provide a complete system for the efficient, uniform, and transparent consumption of Services by an end user.

Unless otherwise expressly stated, it is in no way intended that any method or embodiment set forth herein be construed as requiring that its steps be performed in a specific order. Accordingly, where a method, system, or computer program product claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

### BRIEF DESCRIPTION OF THE DRAWINGS

The accompanying drawings, which are incorporated in and constitute part of this specification, illustrate embodiments of the invention, and together with the description, serve to explain the principles of the invention. The embodiments described in the drawings and specification in no way limit or define the scope of the present invention.

FIG. 1 illustrates the computer system of one embodiment of the present invention.

FIG. 2 illustrates a logical overview of one embodiment of the 1-Drag system and method used as a Services end user interface.

FIG. 3 illustrates a logical overview of one embodiment of the 1-Drag system and method used as a Services end user interface.

FIG. 4 illustrates a logical overview of one embodiment of the HERMES system and method used as a Services agent.

FIG. 5 illustrates a logical overview of one embodiment of the HERMES and 1-Drag system and method used as a complete system to consume Services.

FIG. 6 illustrates a logical overview of one embodiment of the 1-Drag system deployed in a corporate environment.

FIG. 7 illustrates a logical overview of one embodiment of the HERMES system and method used to consume Services.

FIG. 8 shows one embodiment of the 1-Drag system and method being deployed on a user's desktop in a GUI environment.

FIG. 9 shows one embodiment of the 1-Drag system and method which shows the 1-Drag system prompting the user for initialization information.

FIG. 10 shows one embodiment of the 1-Drag system and method as deployed on a user's desktop GUI.

FIG. 11 shows one embodiment of the 1-Drag system and method as deployed on a user's desktop GUT and connected to the HERMES Service agent, which is providing an email Service.

FIG. 12 shows one embodiment of the 1-Drag system and method as deployed on a user's desktop GUI and connected to the HERMES Service agent, which is providing an email Service, and where the user is using the email Service.

FIG. 13 shows one embodiment of the 1-Drag system and method as installed on a user's GUI desktop.

### DETAILED DESCRIPTION OF THE INVENTION

In one embodiment of the present application, HERMES (Heterogeneous Resources Management Enterprise System) acts as a Service agent which interacts with a Web Service through its WSDL or other service interface. HERMES provides a uniform application interface (i.e. acts as a middle man) for a plurality of Services, each with its own application interfaces. HERMES hides the communication interface associated with a particular Service and provides a standard and uniform interface in its place, allowing applications to be built for consuming Services which are Service independent. This allows HERMES to assume the identity of a specific user for the purpose of requesting and consuming a Service. In another embodiment, HERMES may also include a user interface such as a graphical or command line user interface.

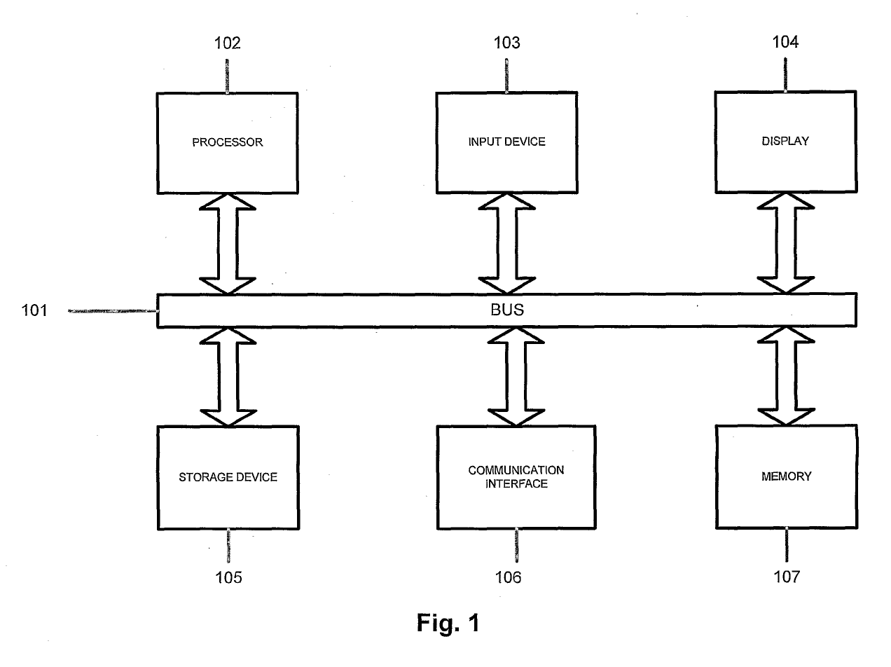

The system and method of the present invention can be carried out using a processor programmed to carry out the various embodiments of the present invention. One such programmed microprocessor includes a programmed computer, depicted in FIG. 1. A computer system, as known in the art, generally includes a bus 101 for communicating data and instructions. The system also includes a memory 107 in communication with the bus 101 and used for storing data and instructions. The system also includes a processor 102 in communication with the bus 101, and used for executing programmed instructions such as those for executing the system and method of the present invention. A storage device 105 may also be connected to the bus 101 and used to provide non-volatile storage of data and instructions. The computer system in one embodiment includes a personal computer (PC) containing program code which causes the processor 102 to carry out the HERMES Service agent and/or the 1-Drag system of the present invention.

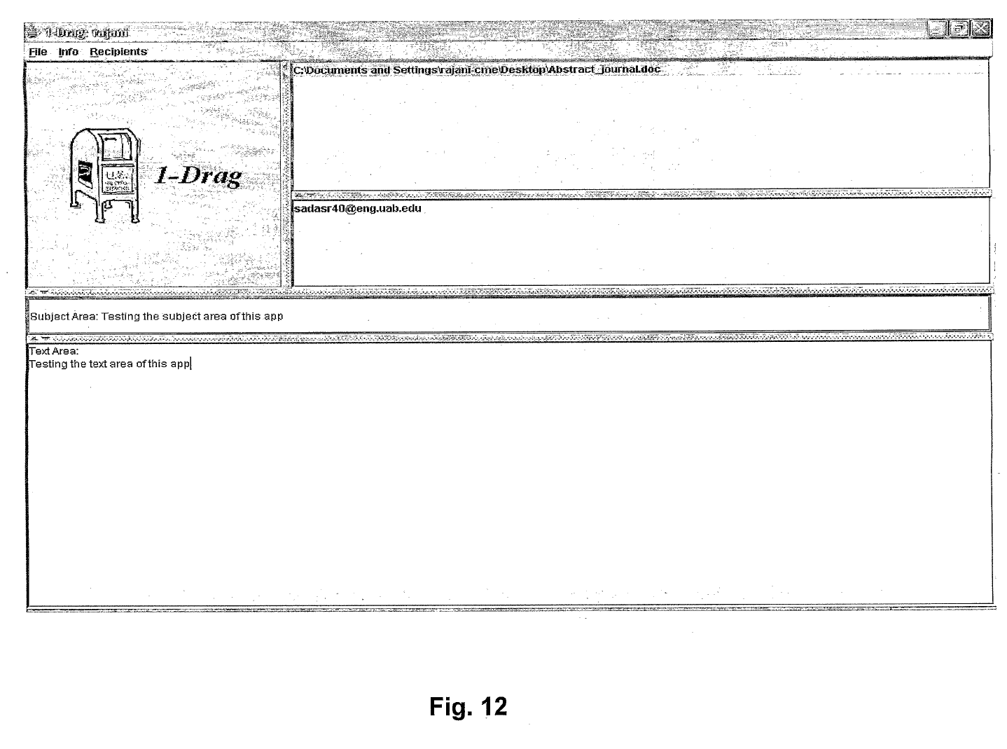

The processor 102 in FIG. 12 can be an x-86 compatible processor, including a Pentium IV, manufactured by Intel Corporation, or an Athlon processor, manufactured by Advanced Micro Devices Corporation. Processors utilizing other instruction sets may also be used, including those manufactured by Apple, IBM, or NEC.

The input device 103 in FIG. 1 could be an alphanumeric input device such as a keyboard, a position input device such as a mouse, or a video input device such as a digital camera, each connected to the bus 101 of the computer system. The communication interface 106 includes a wired or wireless network interface device. The display device 104 of the system includes a cathode ray tube (CRT) computer monitor or a liquid crystal display (LCD).

It will be apparent to those skilled in the art that various devices may be used to carry out the system and method of the present invention, including cell phones, personal digital assistants, wireless communication devices, or dedicated hardware devices designed specifically to carry out the system and method of the present invention. The various embodiments of the present invention, while disclosing a logical order of steps performed, are not intended in any way to be limited to the order in which those steps are recited in the present application. Furthermore, while various embodiments provided in the current application refer to the invention classes of methods, systems, or computer program products, it should be noted that the present invention may be carried out, embodied, or claimed in any statutory class.

For each available Service in one embodiment of HERMES, a Service Profile is created. The Service Profile defines or stores information necessary to consume the requested Service, and can include user specific information such as login, password, financial information, Service location, communication protocol, or any other information necessary to consume the requested Service. The Service Profile can be stored locally on a client device or stored remotely in various embodiments of the present invention. In one embodiment, one or more Service Profiles can be stored in a Service Profile directory, enabling a Web Services agent or interface application to automatically retrieve the appropriate Service Profile for a selected Web Service.

In another embodiment, Services can be incorporated locally into HERMES as plug-ins using its plug-in mechanisms. Additionally, in further embodiments, a front-end user interface such as user forms for the Service can also be defined in HERMES. For example, while consuming a WSDL Service, the user can download the WSDL description as a plug-in into HERMES. Then, the necessary program stubs will automatically be generated by HERMES. Users can then define the front-end user interface to communicate with the SERVICE, if necessary. These front-end user interfaces will then be available to users through the 1-Drag system for consuming the WSDL Web Service.

In one embodiment, HERMES maintains a list of available Services and the Service Profile for each available Service. HERMES can acquire Service Profiles from an online Service directory, the end user, or the Service interface program in communication with HERMES can define a Service Profile based on information supplied to HERMES. In another embodiment HERMES uses rules to automatically create a full or partial Service Profile based on existing Service Profiles or supplied Service information. The sum of all information needed to consume a Service is known as the Service Input. The Service Profile may define the Service Input for a given Service. For example, a certain type of file, such as a graphic file or text file may be necessary input to the selected Service in addition to a user's login. At least part of the Service Input can be stored in the form of a customer profile in various embodiments of the present invention, with the customer profile storing information such as a user's name, login information, contact information, financial information, identity information, or demographic information. The customer profile can be stored on a user's client device, or remotely on a network accessible device.

The Service Profile can also store any necessary security information, such as a digital fingerprint, signature, or public encryption key.

In another embodiment, once the user provides any necessary information defined in the Service Profile, HERMES is able to assume the user's identity and consume the requested Service. For example, in one embodiment, HERMES forwards the Service Input to the associated Service provider. Then, HERMES receives Service output and forwards it to the end user or the end user's Service interface application. HERMES may also forward additional data about the Service or transaction to the end user or interface application, such as transaction time or error messages.

In another embodiment, HERMES supports preferred Service providers. When more than one Service is available to satisfy the user's Service request, the user can define a preferred Service Provider from among a group of Service providers. Additionally, the user can define rules to choose the best Service provider as a function of the particular Service request.

Since HERMES may be remote from the end user or the Service interface application, HERMES in one embodiment communicates with the Service interface application or user using a secure mode of communication, such as encrypted TCP/IP communications.

The 1-Drag Icon system and method of the present application provides a consistent and uniform means by which an end user can consume Services. In one embodiment of the present invention, the I-Drag system provides a uniform graphical user interface to an end user, such as a person, who wants to consume one or more Services. In another embodiment of the present application, a command line interface is used. In a further embodiment, the 1-Drag system can be combined with a Service agent such as HERMES to provide a comprehensive system for consuming Services. The 1-Drag system can also be extended to interact directly with one or more Services, or could be integrated with a Services agent.

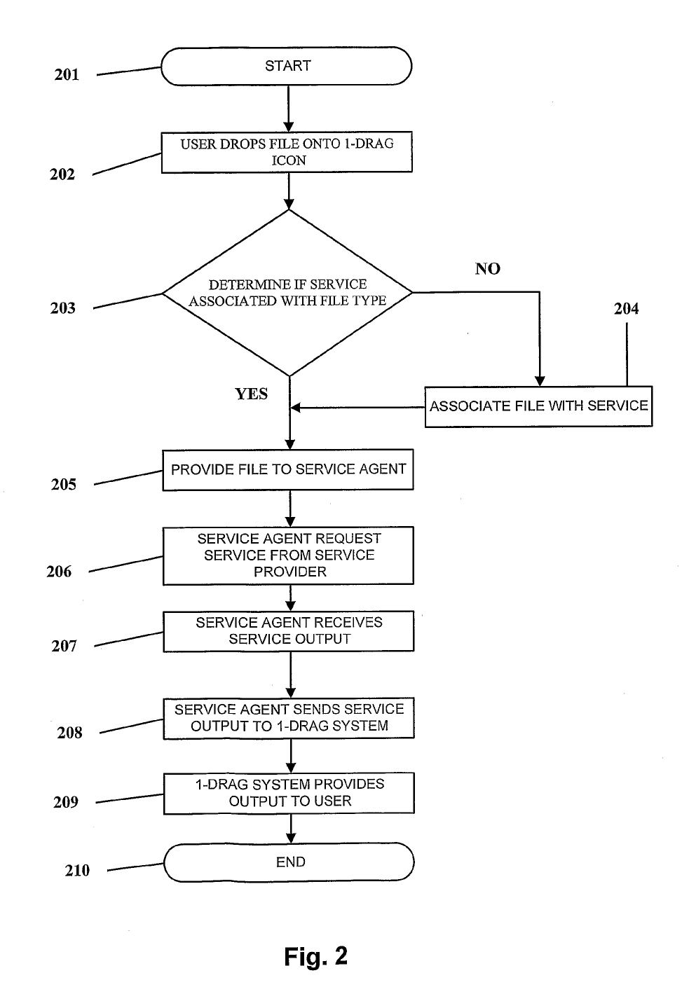

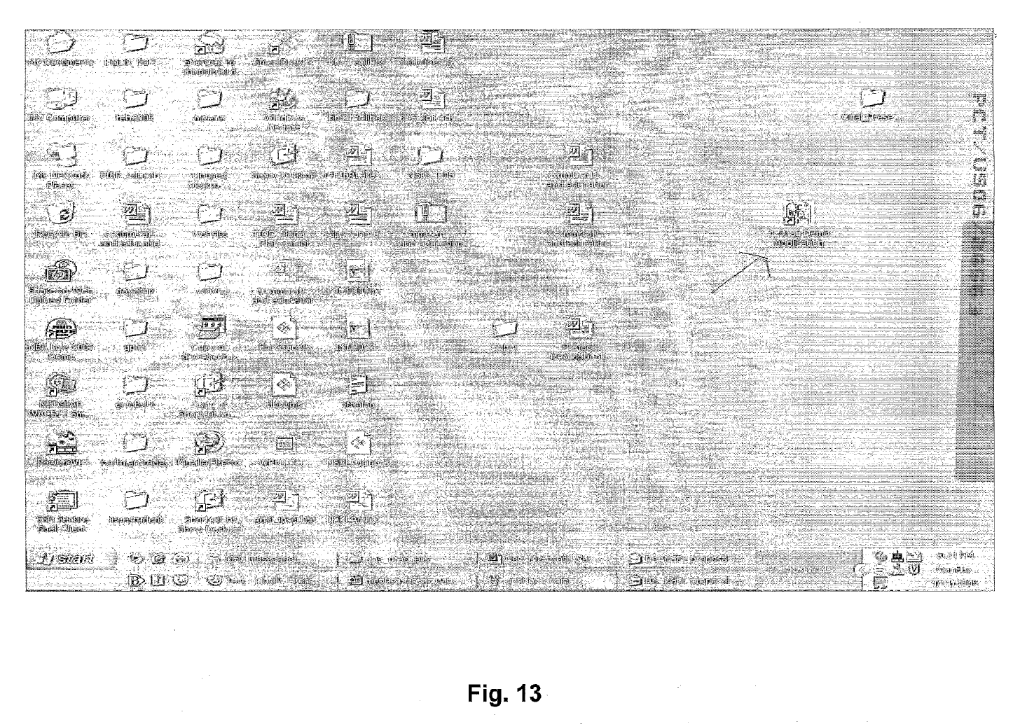

In one embodiment of the present application, the 1-Drag system acts as a user interface in communication with a Service agent. In another embodiment, the HERMES Service agent, described above, is in communication with the 1-Drag system. In the embodiment of the 1-Drag system depicted in FIG. 2, Services are consumed using a window and/or icon in a graphical user interface (GUI) environment, such as the GUI in the Microsoft Windows environment. In this embodiment, the 1-Drag Icon is in communication with a Service agent, such as HERMES, with a graphical icon on the user's desktop representing the 1-Drag system, as well as another icon representing an electronic file which is part of the Service Input for a requested Service. One such embodiment of a GUI with the 1-Drag system installed is seen in FIG. 13.

In the embodiment of FIG. 2, the user provides a file to the 1-Drag system by dropping the icon representing that file onto the 1-Drag icon 202, activating the 1-Drag system. Next, the 1-Drag system determines if an association exists between the file and one or more Services 203. If no Service is associated with the file, then the embodiment of FIG. 2 allows the user to associate the file 204 with one or more Services using a variety of association methods. Then, the file is provided to the associated Service 205 via the Service agent, and control is given to the Service agent, which sends the Service Input to the selected Service provider. The Service agent then request service from the Service provider 206. Once the Service performs the requested Service transaction, the Service output is received 207 by the Service agent, and is then sent to the 1-Drag system 208. Finally, the 1-Drag system provides the output to the user 209, for example, in a GUI window, completing consumption of the requested Service 210.

Another embodiment of the present invention provides a method for providing one or more Web Services. First, a Web Service is operated on a network. The Web Service then receives a service request from a Web Services agent. The Web Services agent can be HERMES, such as illustrated in the embodiment of FIG. 2, wherein the service request is generated by transforming an input in accordance with a Service Profile describing the Web Service. The Web Service then processes the service request to generate a Service output, and sends the Service Output to the Web Services agent.

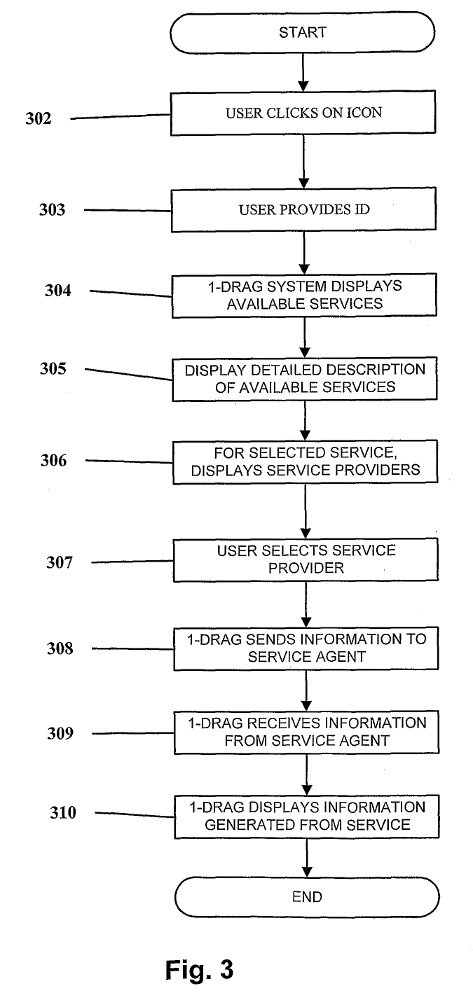

FIG. 3 illustrates the logical overview of one embodiment of a user's interaction with the 1-Drag system. First, a user using a GUI interface clicks on the 1-Drag Icon 302. Second, the user is prompted for a user ID, and provides his user ID 303 to the 1-Drag system. Third, the 1-Drag system displays a listing of available Services 304. Fourth, the 1-Drag system displays a detailed description of available Services 305. Next, the user selects a Service, and for the selected Service type, the 1-Drag system displays a listing of available Service providers 306. Then, the user selects 307 a particular Service provider for the desired Service. Next, the 1-Drag system sends the user's information, and any required Service Input, to the Service Agent 308 so that the requested Service can be performed. The 1-Drag system then receives the resulting information from the Service provider 309 via the Service agent. Finally, the 1-Drag system displays the information received from the Service 310 to the user.

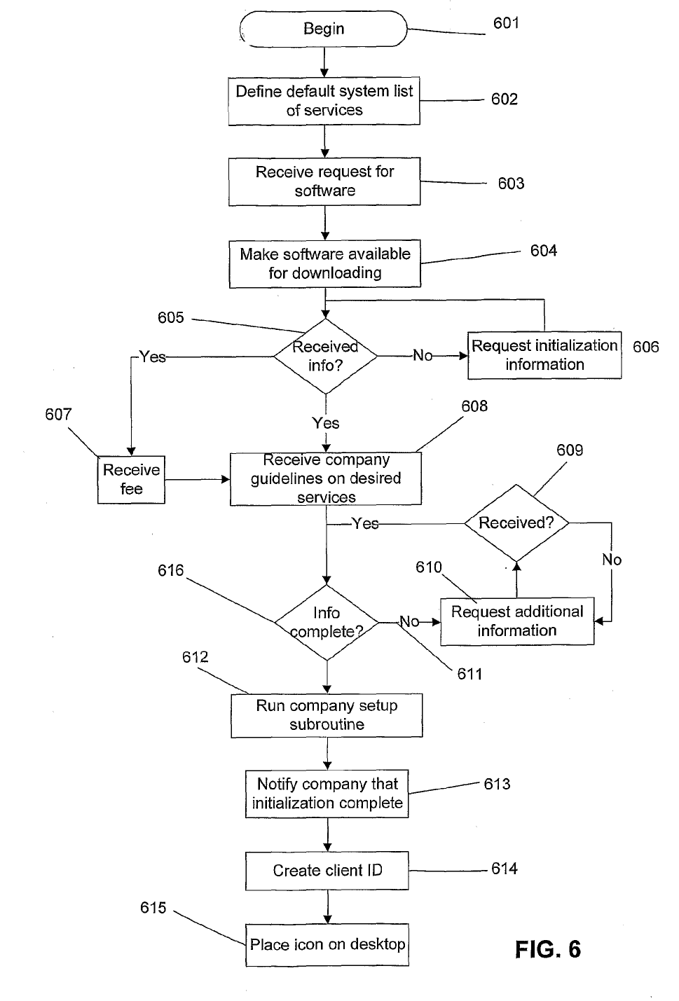

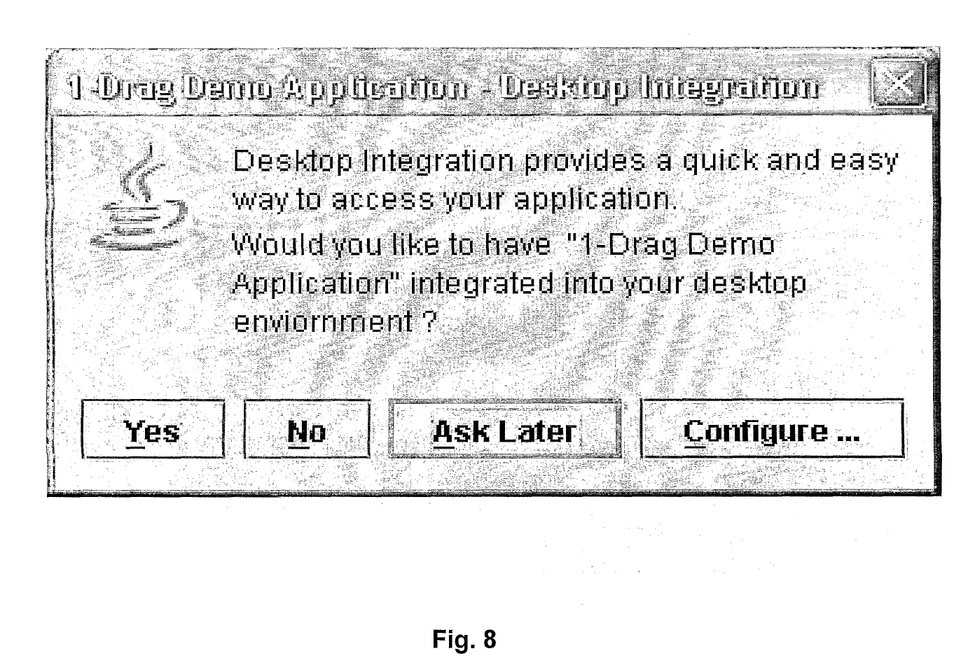

In another embodiment of the present invention, the 1-Drag Icon, such as the 1-Drag Icon illustrated in the embodiment of FIG. 3, is supplied by a Web Service provider on a web site to facilitate consumption of the Web Service provider's Web Services. First, the Web Service provider provides a web page with a link or other means for a user to download and setup the 1-Drag system. The user then visits the web page and downloads the icon to the user's client device. One such embodiment for installing and deploying the 1-Drag system via a downloadable icon is illustrated in the embodiments of FIGS. 6 and 8. Next, the user executes an installation routine, and the 1-Drag Icon is placed on the graphical user interface of the user's client device, which is illustrated in FIG. 13 in one embodiment of the present invention. Thereafter, the user is able to efficiently consume one or more Web Services provided by the Web Service provider by simply dragging and dropping one or more icons onto the 1-Drag Icon. For example, the Web Service provider may operate a web site selling books online. To facilitate the buying process, the book seller provides a downloadable 1-Drag Icon for consumers to download and install. Thereafter, the consumer can purchase a book by simply dragging and dropping a file onto the installed 1-Drag Icon instead of having to make a number visits, and perform numerous checkouts, at the book seller's web site. The dropped icon can represent any type of information in embodiments of the present invention, such as an email message, text message, graphic file, sound file, multi-media file, web page, video file, word processing file, binary file, text file, or executable file. In the current embodiment, the file dropped could represent the user's account information, enabling the user to purchase a book by simply dragging and dropping a file onto a 1-Drag Icon.

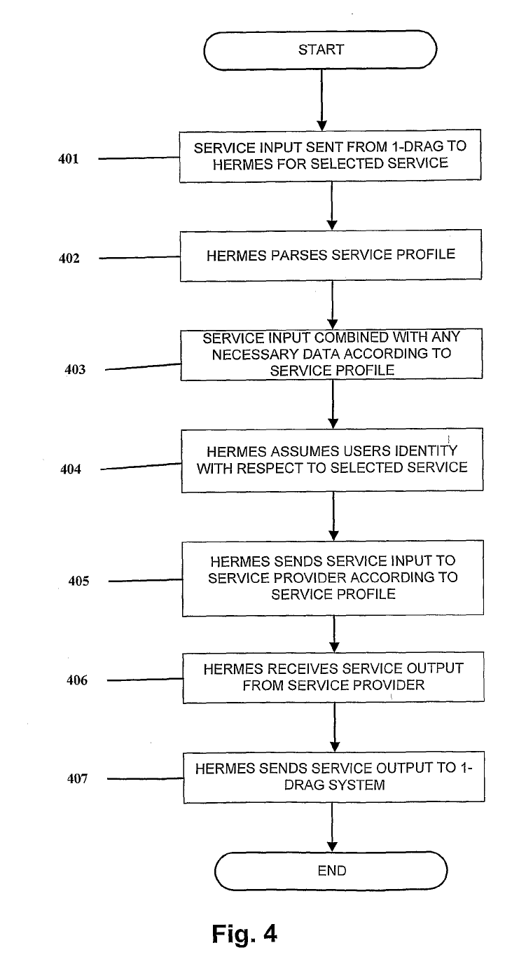

In the embodiment of FIG. 4, HERMES is acting as a Service agent in communication with a Service interface for an end user, such as the 1-Drag system. First, Service Input is sent from the 1-Drag system to HERMES 401 for the selected Service. Second, HERMES parses the Service Profile 402 to determine what user information and data are necessary input for the selected Service. Third, the Service Input provided by the 1-Drag system is combined 403 with any other necessary input data specified in the Service Profile for the selected Service. Once HERMES has all necessary information for the Service Input, HERMES is able to assume the user's identity 404 for the purpose of consuming the selected Service. HERMES then sends the Service Input to the selected Service provider 405 according to the provider's Service profile. Next, HERMES receives the Service output from the Service provider 406. Finally, HERMES sends the received Service output to the 1-Drag system 407 so that it can be received by the end user.

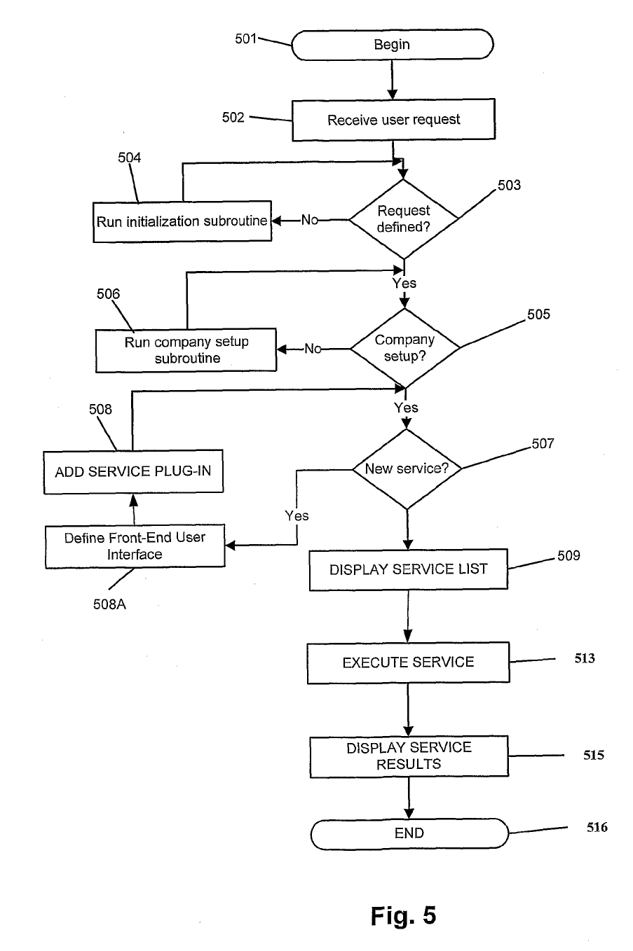

In FIG. 5, one embodiment of the present application is illustrated where the 1-Drag system acts as a Service interface for an end user in a corporate environment, and HERMES is deployed as a Service agent and a local Service provider. The embodiment of FIG. 5 thus illustrates an automated task simplification routine which facilities the consumption of Services in a corporate environment. First 501, the system receives a user request 502 for a selected Service 502. Second, the system determines if the request is defined 503, and if not, runs an initialization routine 504. If the Service is not defined, the system runs the company setup subroutine 506. Next, the system of FIG. 5 determines if the requested Service has been requested before, or if this is the first time it has been selected 507. If the requested Service is new 507, then the Service may be added locally by the addition of a Service plug-in 508. Additionally, the user may define a front-end user interface 508A. At 509, the system displays the default tasks list and descriptions, allowing the user to choose the appropriate Service, causing the system to execute the desired Service 513. Finally, in this embodiment, the system displays the output of the requested Service 515, providing the output data to the end user.

The embodiment in FIG. 6 illustrates the Service initialization routine 504 and company setup routine 506, whereby the system places a 1-Drag icon on the user's desktop for the efficient consumption of Services in a corporate environment. The embodiment of FIG. 6 illustrates the use of a complete system for the consumption of Services by combining the HERMES Service agent and the 1-Drag Icon system. First, a default list of Services is defined 602. Second, the system receives a request from the end user's client computer for a new software download 603 consisting of the 1-Drag Icon, causing the user's computer to download the 1-Drag software to perform the requested Service 604. One embodiment of the step performed in 604 is illustrated in FIG. 8, which shows one embodiment of the 1-Drag system and method being deployed on a user's desktop in a GUI environment.

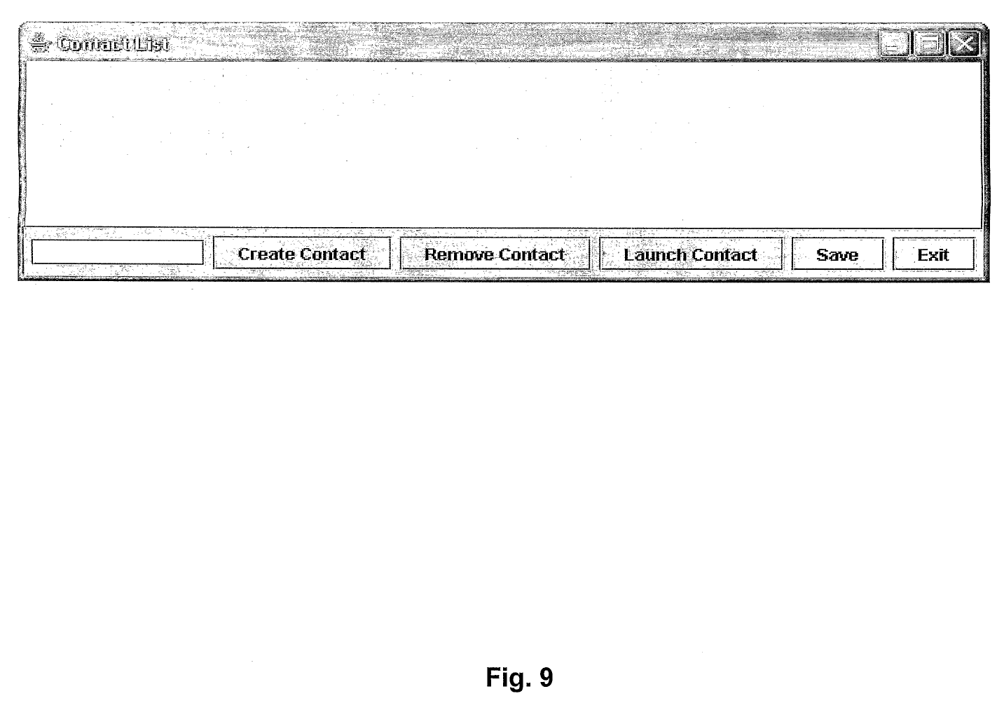

The system then determines if all information necessary for downloading the 1-Drag Icon was received 605, and if it was not, the system further request initialization information 606. On embodiment of the step performed in 606 is illustrated in FIG. 9, which shows the 1-Drag system prompting the user for initialization information, which is contact information in the embodiment of FIG. 9, where the Service is an email client.

If a fee is necessary to download the 1-Drag Icon, the system determines if the fee was paid 607. Next, the system receives the company's guidelines on desired services 608. The system then determines if complete information is available 616 before running the company setup routine 612. If the information is not complete 611, additional information is requested 610 until the information is complete. Then, the 1-Drag system runs the company setup routine 612 so that the 1-Drag system can be installed. Next, the company is notified that 1-Drag setup is complete 613, allowing the user to create a 1-Drag client ID 614. After the end user creates a 1-Drag client ID, the 1-Drag Icon is placed on the user's desktop 615, providing the end user an easy and uniform means for consuming Services.

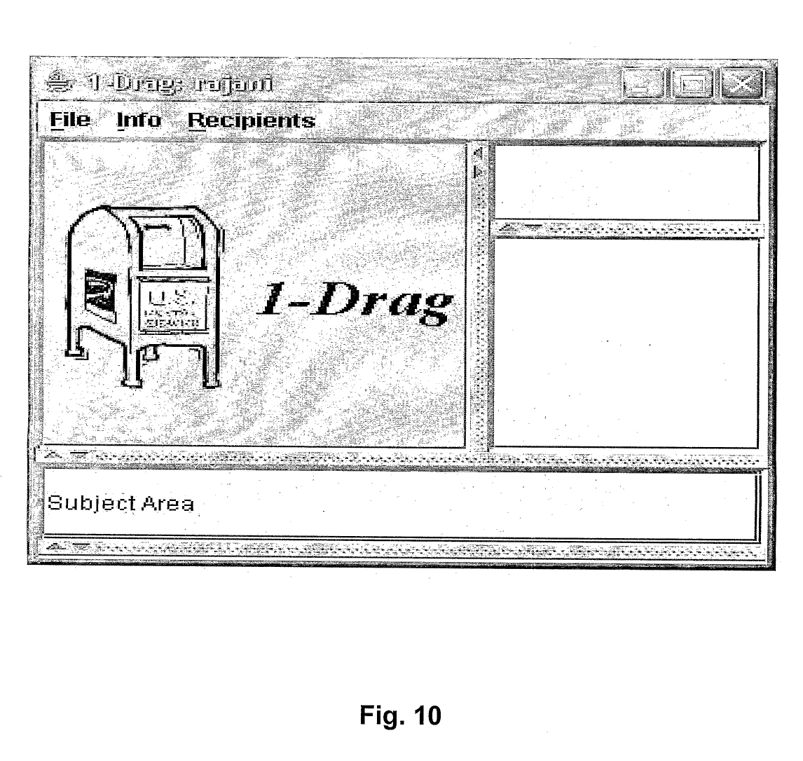

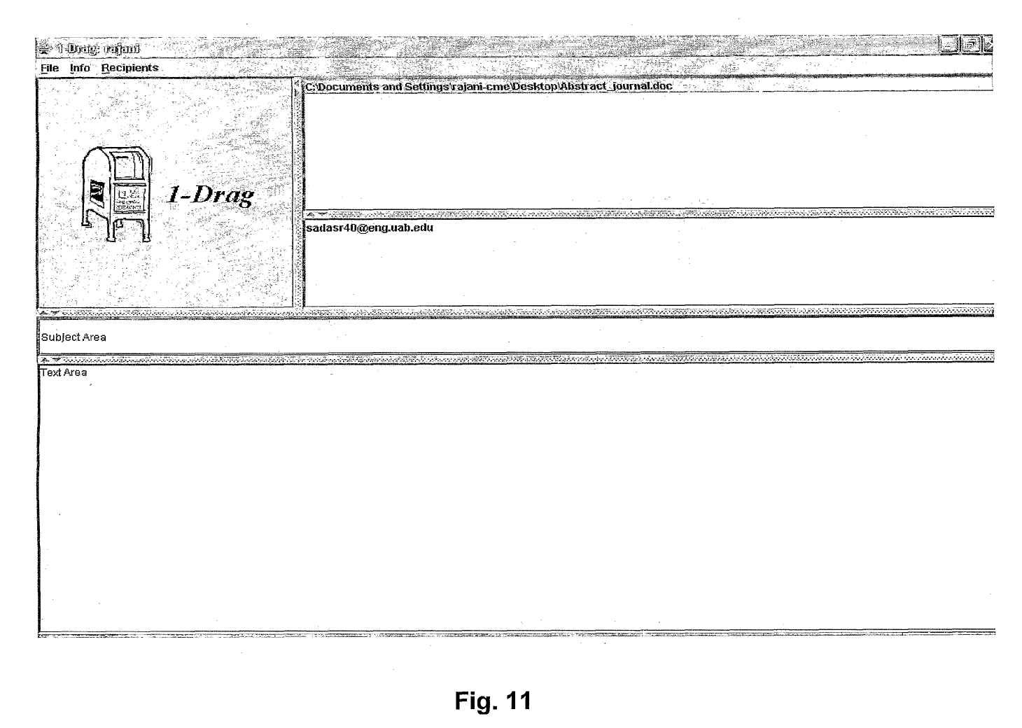

One embodiment of the HERMES Service agent in communication with the 1-Drag system is illustrated in FIG. 10. In this embodiment, HERMES is acting as a Service agent for an email Service, and the 1-Drag Service interface connected to HERMES is shown in FIG. 10. FIG. 11 further depicts the embodiment of FIG. 10, and illustrates the 1-Drag Service interface interacting with the email Service through HERMES. It can be seen in FIG. 11 that part of the Service Input is formed by a file attachment “Abstract_Journal.doc”, an email address “jdoe@eng.uab.edu”, Subject Area input text, and Text Area input text. FIG. 12 further depicts the embodiments of FIGS. 10 and 11, and shows the user providing input data into the Subject Area and Text Area of the 1-Drag Service interface.

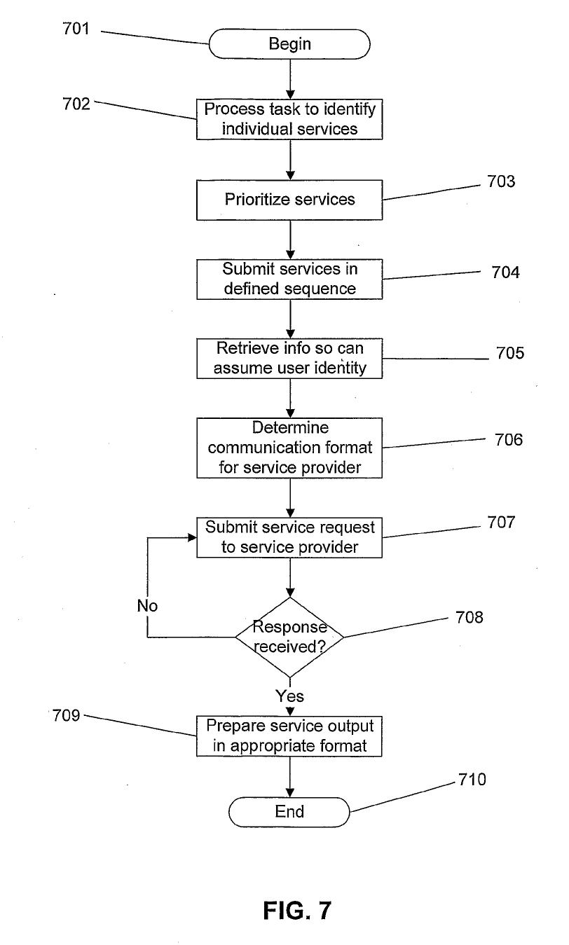

The embodiment of FIG. 7 illustrates one way in which HERMES can process multiple Services or tasks from one or more Service interfaces, such as the 1-Drag system. First, HERMES processes submitted tasks to identify the individual Services requested 702. HERMES then prioritizes the requested Services 703. Prioritization may be accomplished in a variety of ways, including the use of priority rules. Next, the requested Services are submitted to Service providers 704 in the sequence defined in the priority step 703. For each requested Service, HERMES retrieves all necessary information 705, such as user ID, so that HERMES can assume the requesting user's identity. Next, HERMES determines the appropriate communications format for the selected Service provider 706 based on the Service provider's Service Profile. HERMES then submits the Service request for each selected Service provider 707, and determines if a response was received 708. Finally, when a response is received, HERMES transforms the Service output into the appropriate format 709, depending on the output format specified in the Service Profile.

The present invention has been illustrated in relation to embodiments which are intended in all respects to be illustrative rather than restrictive. Those skilled in the art will realize that the present invention is capable of many modifications and variations without departing from the scope of the invention.

We claim:

1. A method for a user to consume web services using a graphical user interface of a client device, the method comprising the steps of:
a. storing a first icon on the graphical user interface;
b. storing a second icon on the graphical user interface;
c. selecting the second icon by the user using the graphical user interface;
d. dragging the second icon by the user and dropping it onto the first icon to initiate a service request using an input represented by the second icon;
e. generating the service request using the input and sending the service request to a web service for processing; and
f. receiving at the client device a service output from the web service.

2. The method of claim 1, wherein the generating step comprises the steps of:
a. matching the input with a web service;
b. selecting a web services provider which provides the web service;
c. using the input to generate the service request; and
d. sending the service request to the web service.

3. The method of claim 2, wherein the using step comprises the steps of:
a. storing a service profile associated with the web service, wherein the service profile defines the information necessary to generate service requests compatible with the web service; and
b. generating the service request so that it is compatible with the web service by transforming the input based on the service profile.

4. The method of claim 2, further comprising the steps of:
a. displaying a list of one or more web service providers which can provide the web service; and
b. selecting by the user a web service provider to provide the web service.

5. The method of claim 2, further comprising the steps of:
a. determining a list of one or more web services that the user is authorized to use;
b. displaying a list of one or more web service providers which can provide the one or more web services; and
c. selecting by the user a web service provider to provide the web service.

6. The method of claim 3, wherein the generating step comprises the steps of:
a. comparing the input with the service profile to determine a data item needed to generate the service request; and
b. generating the service request by supplementing the input based on the service profile.

7. The method of claim 2, wherein the using step comprises the steps of:
a. storing a service profile associated with the web service, wherein the service profile defines the information necessary to generate service requests compatible with the web service;
b. storing a customer profile which contains personal information associated with the user; and
c. generating the service request in accordance with the service profile by combining information from the input with information from the customer profile.

8. The method of claim 1, wherein the generating step comprises the steps of:
a. providing the input to a web services agent, wherein the web services agent generates and sends the service request to an appropriate web service; and
b. receiving by the web services agent a service output and forwarding the service output to the client device.

9. The method of claim 1, wherein the generating step comprises the steps of:
a. providing the input to a web services agent;
b. performing by the web services agent the following steps:
i. matching the input with a web service;
ii. selecting a web service provider which provides the web service;
iii. using the input to generate the service request;
iv. sending the service request to the service provider and receiving a service output from the service provider; and
v. forwarding the service output to the client device.

10. The method of claim 1, wherein the generating step comprises the steps of:
a. providing the input to a web services agent;
b. performing by the web services agent the following steps:
i. matching the input with a web service;
ii. selecting a web service provider which provides the web service;
iii. retrieving a customer profile which contains personal information associated with the user;
iv. combining information from the input with information from the customer profile so that the service request is compatible with the web service;
v. sending the service request to the web service provider and receiving a service output from the web service provider, and
vi. forwarding the service output to the client device.

11. The method of claim 1, wherein the storing a first icon step comprises the steps of:
a. receiving a request from the user for a web service;
b. determining one or more web services that the user is authorized to access using the client device; and
c. storing a first icon on the graphical user interface, wherein the first icon represents a method for consuming the one or more web services.

12. The method of claim 11, further comprising the step of charging the user a fee to store the first icon on the graphical user interface of the client device.

13. The method of claim 1, wherein the second icon represents at least one of an email message, text message, graphic file, sound file, multi-media file, web page, video file, word processing file, binary file, text file, or executable file.

14. The method of claim 1, further comprising the step of displaying at least a portion of the service output on the graphical user interface.

15. The method of claim 7, wherein the customer profile stores at least one of the user's name, login information, contact information, financial information, identity information, or demographic information.

16. The method of claim 8, wherein the web services agent does not reside on the client device.

17. The method of claim 1, wherein a client device is at least one of a cell phone, personal digital assistant, personal computer, workstation, server, laptop, or set top box.

18. The method of claim 1, wherein the web service is executed on the client device and is one of an executable application or a web browser plug-in.

19. The method of claim 8, wherein the web services agent is executed on the client device and is one of an executable application or a web browser plug-in.

20. The method of claim 3, further comprising the step of using rules to automatically generate at least a portion of the service profile.

21. The method of claim 3, further comprising the step of using rules to automatically generate at least a portion of the service profile based on at least one or more existing service profiles.

22. The method of claim 3, further comprising the step of receiving the service profile from a service profile directory.

23. The method of claim 22, wherein the service profile directory is stored on the client device.

24. The method of claim 1, further comprising the step of charging the user a fee for generating the service request.

25. The method of claim 1, wherein the storing a first icon step comprises the steps of:
a. downloading a first icon to the client device from a network accessible device; and
b. storing the first icon on the graphical user interface.

26. The method of claim 1, wherein the service output is at least one of an email message, text message, graphic file, sound file, multi-media file, web page, video file, word processing file, binary file, text file, or executable file.

27. The method of claim 7, wherein the customer profile is stored on the client device.

28. The method of claim 7, wherein the customer profile is stored on a network accessible device.

29. The method of claim 1, wherein the storing a first icon step comprises the steps of:
a. providing by a web services provider a first icon on a web site, wherein the first icon represents a method for consuming one or more web services provided by the web services provider;
b. viewing the web site by the user using the client device;
c. downloading and installing the first icon onto the client device; and
d. storing the first icon on the graphical user interface of the client device, wherein the first icon enables the user to consume the one or more web services.

30. A method for consuming web services, the method comprising the steps of:
a. providing a first application interface for communicating with a client device;
b. providing a second application interface for communicating with a web service;
c. receiving at the first application interface an input from the client device;
d. using the input to generate a service request compatible with the web service;
e. sending from the second application interface the service request to the web service;
f. receiving a service output from the web service; and
g. forwarding the service output to the client device.

31. The method of claim 30, further comprising the steps of:
a. matching the input with a web service; and
b. selecting a web services provider which provides the web service.

32. The method of claim 30, wherein the using step comprises the steps of:
a. storing a service profile associated with the web service, wherein the service profile defines the information necessary to generate service requests compatible with the web service; and
b. transforming the input based on the service profile to generate a service request compatible with the web service.

33. The method of claim 30, wherein the using step comprises the steps of:
a. storing a service profile associated with the web service, wherein the service profile defines the information necessary to generate service requests compatible with the web service;
b. storing a customer profile which contains personal information associated with a user; and
c. combining in accordance with the service profile information from the input with information from the customer profile to generate a service request compatible with the web service.

34. The method of claim 30, wherein the input is at least one of an email message, text message, graphic file, sound file, multi-media file, web page, video file, word processing file, binary file, text file, or executable file.

35. The method of claim 33, wherein the customer profile stores at least one of the user's name, login information, contact information, financial information, identity information, or demographic information.

36. The method of claim 30, wherein the web service is executed on the client device and is one of an executable application or a web browser plug-in.

37. The method of claim 32, further comprising the step of receiving the service profile from a service profile directory.

38. The method of claim 30, further comprising the step of charging a user a fee for generating the service request.

39. A method for providing a web service, the method comprising the steps of:
a. operating the web service;
b. receiving at the web service a service request from a web services agent, wherein the web services agent generated the service request by transforming an input in accordance with a service profile describing the web service;
c. processing the service request to generate a service output; and
d. sending the service output to the web services agent.

40. The method of claim 9, wherein the web services agent received the input from a client device.

41. The method of claim 40, wherein the web services agent is executed on a device separate from the client device.

42. A method for processing web services, the method comprising the steps of:
a. storing a list of one or more inputs to be used in generating service requests;
b. associating a web service with each input in the list of inputs;
c. for each input in the list of inputs, performing the steps of:
i. using the input to generate a service request compatible with the associated web service; and
ii. adding the generated service request to a list of service requests;
d. ordering the list of service requests; and
e. submitting in order each service request to its associated web service.

43. The method of claim 42, wherein the using step comprises the steps of:
a. retrieving a service profile associated with the web service, wherein the service profile defines the information necessary to generate service requests compatible with the web service; and
b. transforming the input based on the service profile to generate a service request compatible with the web service.

44. The method of claim 42, wherein the using step comprises the steps of:
a. retrieving a service profile associated with the web service, wherein the service profile defines the information necessary to generate service requests compatible with the web service;
b. retrieving a customer profile which contains personal information associated with a user who provided the input; and
c. combining in accordance with the service profile information from the input with information from the customer profile to generate a service request compatible with the web service.

45. The method of claim 42, wherein the input is at least one of an email message, text message, graphic file, sound file, multi-media file, web page, video file, word processing file, binary file, text file, or executable file.

46. The method of claim 44, wherein the customer profile stores at least one of the user's name, login information, contact information, financial information, identity information, or demographic information.

47. The method of claim 43, wherein the service profile is retrieved from a service profile directory.

48. The method of claim 42, wherein the using step comprises the step of using the input by a web services agent to generate a service request compatible with the associated web service.
